(19) United States
(12) Patent Application Publication
(10) Pub. No.: US 2023/0284600 A1
(43) Pub. Date: Sep. 14, 2023

(54) SMART AQUACULTURE GROW OUT SYSTEM

(71) Applicant: Rynan Technologies Pte. Ltd., 05-57 Paya Lebar Square (SG)

(72) Inventors: My T Nguyen, Tra Vinh Province (VN); Toan Q. Tran, Tra Vinh Province (VN); Cuong Q. Hong, Tra Vinh Province (VN); Tuan T. Lam, Soc Trang Province (VN); Thong A. Nguyen, Tra Vinh Province (VN); Dat T. Bui, Tra Vinh Province (VN); Nam Q. Doan, An Giang Province (VN); Chau M. Bui, Ca Mau Province (VN); Khanh V. Vo, Tra Vinh Province (VN); Toan Q. Tran, Tra Vinh Province (VN)

(21) Appl. No.: 18/040,479

(22) PCT Filed: Aug. 5, 2020
(86) PCT No.: PCT/IB2020/057416

§ 371 Date: Feb. 3, 2023

(51) Int. Cl. A01K 61/80; A01K 61/59

(52) U.S. Cl. CPC A01K 61/80; A01K 61/59

(57) ABSTRACT

There is provided a smart aquaculture grow out system for aquatic species, the system includes a feeder adapted to store aquafeed, the feeder comprising a feed dispensing nozzle, a feed dispenser operable to measure and project aquafeed via the feed dispensing nozzle, and a controller operatively being operable to selectively activate and deactivate the feed dispenser. A set of sensors are operable to acquire sensor data comprising water quality parameters of a pond adjacent to the feeder and images of aquatic species in the pond. A processor receives the sensor data of the grow out system, and determines, based on the sensor data of the grow out system, a metered quantity of aquafeed to provide. The processor transmits a control signal to the controller causing activation of the feed dispenser to measure and project the metered quantity of aquafeed via the feed dispensing nozzle.

### CROSS-REFERENCE TO RELATED APPLICATIONS

None

### FIELD

The present technology relates to aquaculture of fish and shellfish species such as shrimp in general and more specifically to a smart grow out system for monitoring of grow out conditions and distribution of aquafeed using machine learning algorithms, as well as methods of operating the same.

### BACKGROUND

In many parts of the world fish or shellfish aquaculture takes place in enclosures such as water basins. In the case of shrimp aquacultures these basins are called shrimp grow out ponds. The ponds are filled with water from a nearby water body and seeded with shrimp larvae. In intensive and super-intensive shrimp farming, the shrimp are regularly fed so as to optimize rapid growth. In about three to four months shrimp such as Litopeneaus vannamei are ready to be harvested. In such aquaculture, feed accounts for over half of the total production cost. However, shrimp yield and size are often negatively impacted by disease, overfeeding, underfeeding, low dissolved oxygen levels, pollution, pH deviations, water salinity and water temperature. If the shrimp harvest is deficient in yield, the shrimp farm will experience financial losses due to the cost of the investment in feed, in larvae and human resources. In the best case, shrimp ponds will generate a healthy margin. In reality, margins are difficult to predict because of the risks involved.

For example, overfeeding quickly impacts the water quality causing disease outbreaks and high rate of shrimp mortality. On the other hand, underfeeding delays the growth of shrimp leading to lower profit margins. Proper feed management remains a huge challenge plagued with inconsistencies and is highly dependent on the shrimp farmer skill, experience and sometimes luck.

Indeed, daily feed requirements continuously vary and are strongly dependent on the shrimp biomass (i.e., shrimp density and average body weight), fluctuation of water quality (i.e., dissolved oxygen, salinity, pH, turbidity, pollutants and water temperature) and weather conditions (i.e., rainy, sunny and windy). However, continuously adjusting feed requirements based on these parameters is beyond the reach of most if not all shrimp farms.

Automatic shrimp feeders are known to be used to broadcast the feed pellets over the water surface of the shrimp ponds. The pellets sink to the pond bottoms. If the pellets sit on the pond bottom for a length of time, nutrients are leached out into the water leading to lower the nutritional values and ensuing water pollution. Many studies estimated that about 20% of aquafeed remain uneaten by shrimp. Therefore, it is preferred that the feed pellets are in the water for as short a period as possible before shrimp eat them. Applying numerous feedings with small feed quantities is better than fewer feedings with large feed quantities. Automatic shrimp feeders are set to turn on and broadcast metered amounts of aquafeed at preset intervals.

Another issue in aquaculture operations is traceability. Full traceability means that consumers and retailers may trace back the provenance and aquaculture conditions such as location of the grow out pond, feed manufacturer, production location, feed ingredients, production date, expired date, feeding times, and feeding conditions.

### SUMMARY

It is an object of the present technology to ameliorate at least some of the inconveniences present in the prior art. One or more embodiments of the present technology may provide and/or broaden the scope of approaches to and/or methods of achieving the aims and objects of the present technology.

Developer(s) of the present technology have appreciated that automatic shrimp feeders do not solve the problem of smartly adjusting feeding to the numerous parameters at play. Precise feeding would not only reduce feed costs but would also optimize shrimp health and growth. Developer(s) have also appreciated that there is also a need for traceability of the aquaculture grow out systems, whereby the feed inputs as to the nature and the quantify of the feed are recorded and tracked, as well as its origin.

Thus, one or more embodiments of the present technology are directed to a smart aquaculture grow out system.

In accordance with a broad aspect of the present technology, there is provided a smart aquaculture grow out system. The smart aquaculture grow out system includes: a feeder adapted to receive and hold aquafeed, the feeder includes: a feed dispensing nozzle, a feed dispenser connected to the feed dispensing nozzle, the feed dispenser is operable to measure and project aquafeed via the feed dispensing nozzle, a controller operatively connected to the feed dispenser, the controller is operable to selectively activate and deactivate the feed dispenser, a set of sensors is operable to acquire sensor data of the grow out system, the sensor data includes water quality parameters of a pond adjacent to the feeder. The smart aquaculture grow out system includes a processor communicatively coupled to the set of sensors and the controller, the processor is operable to: receive, from the set of sensors, the sensor data of the grow out system including the water quality parameters, determine, based on the sensor data of the grow out system, a metered quantity of aquafeed to provide to the pond, and transmit, to the controller, a control signal causing activation of the feed dispenser to measure and project the metered quantity of aquafeed via the feed dispensing nozzle.

In one or more embodiments of the smart aquaculture grow out system, the set of sensors comprises at least one of: a temperature sensor, a pH sensor, a dissolved oxygen (DO) sensor, a carbon dioxide (CO2) sensor, an ammonia sensor (NH3), a scale, a turbidity sensor, and a salinity sensor.

In one or more embodiments of the smart aquaculture grow out system, the set of sensors includes a camera operable to acquire an image of an aquatic species located in the pond, the processor is operable to determine, based on the image, an approximate size of the aquatic species, the processor is operable to determine the metered quantity of aquafeed further based on the approximate size of the aquatic species.

In one or more embodiments of the smart aquaculture grow out system, the processor is operable to determine, based on the image, an approximate biomass of the aquatic species in the pond, the processor is operable to determine the metered quantity of aquafeed further based on the approximate biomass of the aquatic species.

In one or more embodiments of the smart aquaculture grow out system, the metered quantity of aquafeed comprises: a feed pellet size and a feed pellet weight.

In one or more embodiments of the smart aquaculture grow out system, the processor has access to a set of machine learning algorithms (MLAs) having been trained to determine the metered quantity of aquafeed based on the sensor data includes water quality parameters and images.

In one or more embodiments of the smart aquaculture grow out system, the set of machine learning algorithms (MLAs) has been trained to determine the metered quantity of aquafeed further based on an approximate biomass of the aquatic species and an approximate size of the aquatic species.

In one or more embodiments of the smart aquaculture grow out system, the processor is further operable to: transmit, over a communication network, an indication to order an aquafeed bag includes at least the metered quantity of aquafeed.

In one or more embodiments of the smart aquaculture grow out system, the feed dispenser comprises: a feed dosing mechanism operatively connected to the controller and is operable to provide the metered quantity of aquafeed to an aquafeed inlet, and an air blower in fluid communication with an air inlet, the air inlet is connected to the aquafeed inlet and a feed tube, the air blower is operatively connected to the controller, the air blower is operable to generate an airflow to project the metered quantity of aquafeed received from the aquafeed inlet via the feed dispensing nozzle through the feed tube.

In one or more embodiments of the smart aquaculture grow out system, the smart aquaculture grow out system further comprises a nozzle swing mechanism operatively connected to the feed dispensing nozzle, the nozzle swing mechanism is operable to provide rotative motion to the feed dispensing nozzle to project the metered quantity of food at different angles at a surface of the pond.

In one or more embodiments of the smart aquaculture grow out system, the nozzle swing mechanism comprises: a first gear defining an opening for securing at least a portion of the nozzle, a second gear coupled to the first gear, and a servo motor operatively and rotatably connected to the first gear to provide rotative motion thereto.

In one or more embodiments of the smart aquaculture grow out system, the nozzle swing mechanism is operable to rotate between about −90 degrees to about +90 degrees when the feed dispensing nozzle is directed at a center of the pond.

In one or more embodiments of the smart aquaculture grow out system, the set of sensors further comprises a weather sensor operable to measure at least one of temperature, humidity, wind speed, wind direction and rain.

In one or more embodiments of the smart aquaculture grow out system, the feeder comprises a body and a lid for covering the body, and a locking mechanism operatively connected to the controller for locking the lid to the body, the controller is operable to selectively lock and unlock the locking mechanism upon receipt of another control signal.

In one or more embodiments of the smart aquaculture grow out system, the feeder is associated with a unique identifier, the controller is operable to selectively unlock the locking mechanism upon the receipt of the other control signal, the other control signal is indicative of a match between the unique identifier of the feeder and a unique identifier of an aquafeed bag.

In one or more embodiments of the smart aquaculture grow out system, the controller is operable to transmit the control signal causing activation of the feed dispenser to measure and project the metered quantity of aquafeed via the feed dispensing nozzle only upon receipt of the other control signal.

In one or more embodiments of the smart aquaculture grow out system, the aquatic species comprises one of fish and shellfish.

In one or more embodiments of the smart aquaculture grow out system, the shellfish comprises one of shrimp and prawn.

In one or more embodiments of the smart aquaculture grow out system, the controller comprises the processor.

In accordance with a broad aspect of the present technology, there is provided a feeder system. The feeder system includes: a feed container for receiving aquafeed, the feed container defining a channel extending downwardly from a lower portion thereof, a feed dosing mechanism connectable to the channel, the feed dosing mechanism is operable to supply aquafeed through the channel, a feed dispenser connectable to the channel and to a feed dispensing nozzle, the feed dispenser is operable to project aquafeed from the channel up to the feed dispensing nozzle, and a controller operatively connectable to the feed dosing mechanism and the feed dispenser, the controller is operable to: receive an indication to provide aquafeed, activate, based on the indication, the feed dosing mechanism to supply a metered quantity of aquafeed, and activate, based on the indication, the feed dispenser to project the metered quantity of aquafeed from the nozzle.

In one or more embodiments of the feeder system, the feeder system is associated with a unique identifier, the indication to provide aquafeed comprises a match between the unique identifier of the feeder system and a match between a unique identifier associated with the aquafeed.

A shellfish feeding and growth system includes: a feeder system adapted to receive and hold a supply of shellfish food pellets, said feeder system adapted to throw metered amounts of the food pellets into a pond or vessel containing shellfish at calculated and discrete time intervals in response to commands from a controller, a controller is responsive to a central processing unit or network link providing commands to said feeder system, a central processing unit or network link receiving inputs provided by sensors located in or around said pond or vessel, determining with one or more algorithms the required time intervals and metered amounts of the pellets and providing commands to said controller, said inputs includes inputs is provided by sensors within said pond or vessel, including a pH sensor, a temperature sensor, a turbidity sensor, a salinity sensor and a dissolved oxygen sensor.

In accordance with a broad aspect of the present technology, there is provided a method of operating an aquafeed feeder system, the aquafeed feeder system is associated with a feeder unique identifier, the method is executed by a processor, the processor is connected to a controller of the aquafeed feeder system. the method comprises: receiving the feeder unique identifier associated with the aquafeed feeder system, receiving an aquafeed unique identifier associated with an aquafeed bag, in response to the feeder unique identifier of the aquafeed system matching the aquafeed unique identifier associated with the aquafeed bag: transmitting a signal to the controller of the aquafeed feeder system, the signal thereby causing the aquafeed feeder system to activate a feed dispensing mechanism to measure and project the aquafeed via a feed dispensing nozzle.

In one or more embodiments of the method, the aquafeed unique identifier and the feeder unique identifier comprise a respective QR code.

In one or more embodiments of the method, the method further comprises, prior to said transmitting the signal to the controller: receiving an approximate biomass and an approximate size of aquatic species, determining, based on the approximate biomass and the approximate size of the aquatic species, a metered quantity of aquafeed to provide to the aquatic species, the signal comprises an indication of the metered quantity of aquafeed.

In one or more embodiments of the method, the method further comprises, prior to said determining of the metered quantity of aquafeed to provide the aquatic species: receiving water quality parameters of a pond includes the aquatic species, said determining of the determining of the metered quantity of aquafeed to provide the aquatic species if further based on the water quality parameters.

### Definitions

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a perspective view of a grow out system in accordance with one or more non-limiting embodiments of the present technology.

FIG. 2 depicts a schematic diagram of a feed dispenser of the grow out system of FIG. 1 in accordance with one or more non-limiting embodiments of the present technology.

FIG. 3 depicts a schematic diagram of the interior of the feed dispenser of FIG. 2 in accordance with one or more non-limiting embodiments of the present technology.

FIG. 4 depicts a schematic diagram of the feed container and the feed dosing mechanism of the feed dispenser of FIG. 2 in accordance with one or more non-limiting embodiments of the present technology.

FIG. 5 depicts a schematic diagram of a nozzle swinging mechanism of the feed dispenser of FIG. 2 in accordance with one or more non-limiting embodiments of the present technology.

FIG. 6 depicts a schematic diagram of a feed dosing mechanism of the feed dispenser in accordance with one or more non-limiting embodiments of the present technology.

FIG. 7 depicts a schematic diagram of an aquaculture communication system in accordance with one or more non-limiting embodiments of the present technology.

FIG. 8 depicts a flow chart of a method of operating a feeder of an aquaculture grow out system in accordance with one or more non-limiting embodiments of the present technology

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

Grow Out System

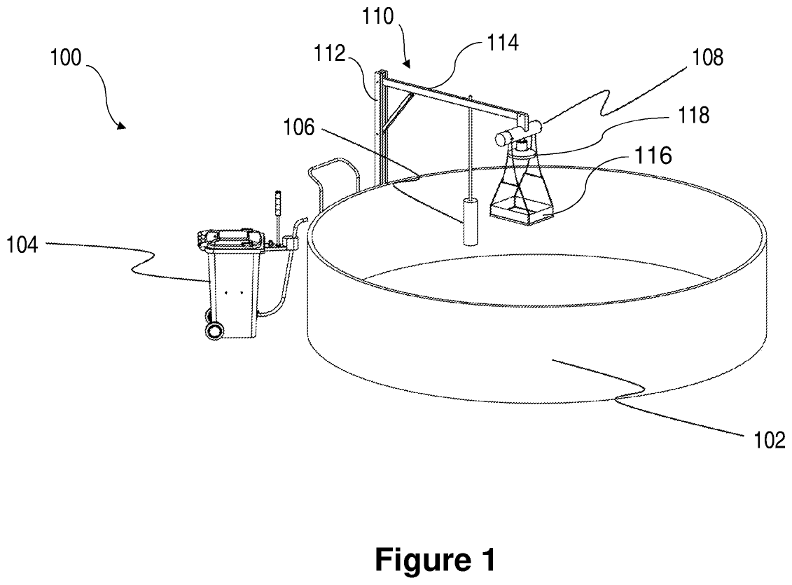

With reference to FIG. 1, there is depicted a perspective view of an aquaculture grow out system 100 in accordance with one or more non-limiting embodiments of the present technology.

The grow out system 100 is used in aquaculture and may be part of an aquaculture farm which may comprise a plurality of grow out systems 100 with ponds of various sizes for nursery and grow-out of fishes and shellfishes including shrimp, prawns and the like.

The grow out system 100 comprises inter alia a pond 102, a feeder 104, a crane 110, a set of sensors 106, a basket 116 and a camera 118.

The pond 102 is an aquaculture basin which is sized and shaped to contain water and where larvae of fish, shellfish, shrimp, or prawns are stocked and grown to harvestable size.

While the pond 102 is illustrated as being in the form of a circular pool, it will be appreciated that the pond 102 may have a different shape or size without departing from the scope of the present technology. As a non-limiting example, the pond 102 have an area of 500 m², 750 m², 1000 m², or 1200 m² and may have a minimum depth of 0.6 m at the shallow end and a maximum depth of 1 m to 2.0 m at the deep end.

The crane 110 is located adjacent the pond 102 and is used to lift and lower material and move material horizontally across the pond 102. The crane 110 is shaped as an inverted L and comprises a beam 112 extending vertically and an arm 114 extending horizontally from a top portion thereof towards the pond 102.

In one or more embodiments, a winch 108 is mounted on a distal end of the arm 114 and a basket 116 is secured to a cable (not numbered) of the winch 108. The winch 108 may be controlled to lift and lower the basket 116 in the water of the pond 102.

The basket 116 is sized and shaped to receive species located in the pond such as fish and shellfish which can be retrieved from the pond 102 using the winch 108. In one or more embodiments, the basket 116 may comprise a scale (not depicted) for weighing species growing in the pond 102.

A camera 118 is secured to the winch 108 and located above the basket 116. In one or more embodiments, the camera 118 may be secured adjacent a distal end of the arm 114. The camera 118 is positioned such that the interior of basket 116 is in its field of view and images of the interior of the basket 116 may be acquired.

The camera 118 is configured to acquire photos and/or videos of the interior of the basket 116, which may comprise fishes and shellfishes such as prawns and shrimps. The camera 118 is connected via a wired or wireless communication link (not depicted) to a communication interface for transmitting and receiving data such as pictures and control commands. The transmitted photos and videos may be analyzed by a processor of an electronic device (not depicted in FIG. 1) to approximately determine a size of the fish or shellfishes as well as a biomass, i.e. density of the fish and shellfishes in the pond 102.

The grow out system 100 comprises a set of sensors 106. The set of sensors 106 are configured to monitor parameters of the grow out system 100 and the species growing therein including inter alia water quality parameters, and fish or shellfish health parameters such as size of the species, biomass and the like.

It will be appreciated that one or more sensors of the set of sensors 106 may be positioned at different locations, such as within the pond 102, adjacent to the pond 102 or may be selectively moved to and removed from the pond 102 by a mechanical system.

The set of sensors 106 comprises inter alia the camera 118, a thermometer (not depicted), a dissolved oxygen (DO) meter (not depicted), a pH meter (not depicted), a turbidity sensor (not depicted), a scale (not depicted), and a salinity sensor or salt meter (not depicted). It will be appreciated that depending on the type of fish or shellfish in the pond 102, different parameters may be monitored by the set of sensors 106. The set of sensors 106 are connected to a communication interface (not depicted in FIG. 1) for transmitting and/or receiving data.

Water quality parameters sensed by the set of sensors 106 include inter alia DO, temperature, pH, salinity, carbon dioxide (CO₂), ammonia (NH₃), nitrite, hardness, alkalinity, hydrogen sulfide (H₂S), biological oxygen demand (BOD).

Health parameters of the species in the pond 102 include: size, weight, visual appearance, biomass, behavior, presence of bacteria.

The set of sensors 106 may transmit sensor data including water quality parameters measurements to an electronic device. It will be appreciated that the set of sensors 106 may transmit sensor data upon receipt of an indication signal, or may transmit the sensor data continuously or at predetermined time intervals.

In one or more embodiments, the grow out system 100 may comprise an additional set of sensors for sensing weather and environmental conditions such as a rain gauge sensor, an anemometer and the like.

The feeder 104 or feed dispenser 104 comprises a body 200 and a lid 202 covering the body 200. Feeder 104 provides transparent information for shrimp traceability including farm identification, pond locations, aquafeed manufacturer identification and aquafeed information, daily feed consumption, expected harvest date and others. It can be turned on/off with a mobile application downloadable to a smart phone.

In a non-limiting example, it has a aquafeed container capacity of about 100 kg, is made of high density polyethylene or other suitable material and can be wheeled in place immediately next to a shrimp pond. As will be described below, it is adapted to store aquafeed of various pellet sizes, such as 1 mm to about 5 mm in diameter and to project these in the shrimp pond at discrete intervals or sequences in response to inputs from a controller 224.

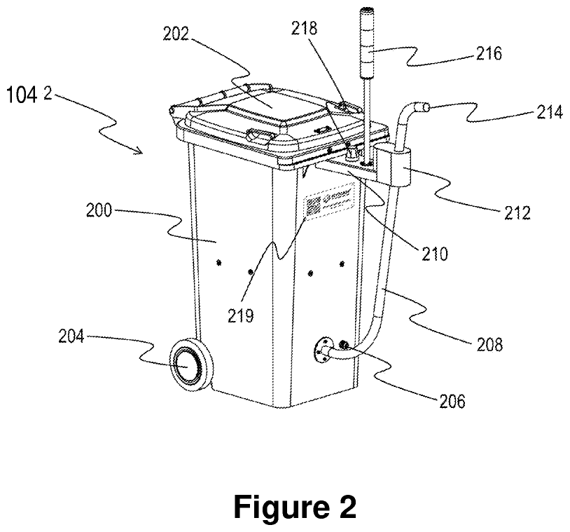

The body 200 is sized and shaped for receiving and storing a supply of aquafeed such as feed pellets for fishes and shellfishes. As best seen in FIG. 2, the body 200 comprises a base (not numbered), a front wall (not numbered), two side walls (not numbered) and a rear wall (not illustrated in FIG. 2). Two wheels 204 are rotatably mounted on opposite sides of the body 200 and enable moving the feeder 104. The front, side and rear walls are substantially vertical and define a cavity 206 in which aquafeed may be received and stored.

It will be appreciated that that the quantity of aquafeed that may be stored is not limited and depends on the size of the feeder 104.

The body 200 comprises a unique identifier 219, which may be a scannable code such as a barcode or a QR code. The unique identifier 219 is used to identify the feeder 104 as well as the location of the grow out system 101, which may be used for traceability purposes. In one or more alternative embodiments, the unique identifier 219 may be in the form of a RFID or NFC tag.

The feeder 104 comprises a lid 202 which is pivotally mounted on a rear wall of the body 200 and which may pivot between a closed position covering and hermetically sealing an entirety of the cavity 206 and an open position which may enable a worker to fill the body 200 with aquafeed.

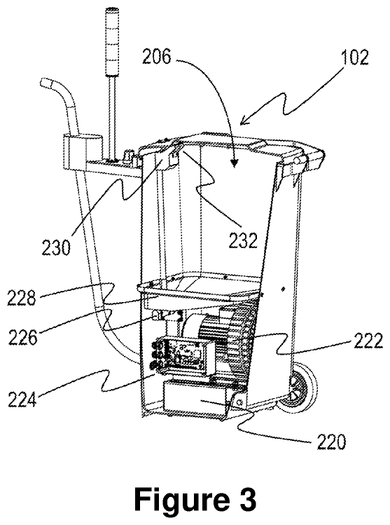

In one or more embodiments, a locking mechanism 230 (as best seen in FIG. 3) may be provided for locking the lid 202 to the body 200, where the locking mechanism 230 may be operatively connected to a controller 224 (best seen in FIG. 3) which may selectively cause the locking mechanism 230 to lock and unlock the lid 202 upon receipt of a signal. As a non-limiting example, the controller 224 may unlock the lid 202 in response to a signal indicating that aquafeed content in the feeder 104 is below a weight, if the unique identifier 219 matches a unique identifier associated with an aquafeed bag (not depicted) and/or an electronic device, and the like.

A socket 206 is located on a front wall of the body 200 for connecting the feeder 104 to a power source (not depicted) using a power cable (not depicted). In one or more embodiments, the socket 206 may be positioned on the base or on another wall of the feeder 104 or may be omitted and the feeder 104 may comprise a battery located inside for providing electrical power thereto.

The feeder 104 comprises a feed pipe 208 extending generally vertically from the front wall up to a feed dispensing nozzle 214 which is coupled to a swing mechanism 212. The swing mechanism 212 is used to provide motion to the feed dispensing nozzle 214 of the feed pipe 208 to project aquafeed in the pond 102 in different directions.

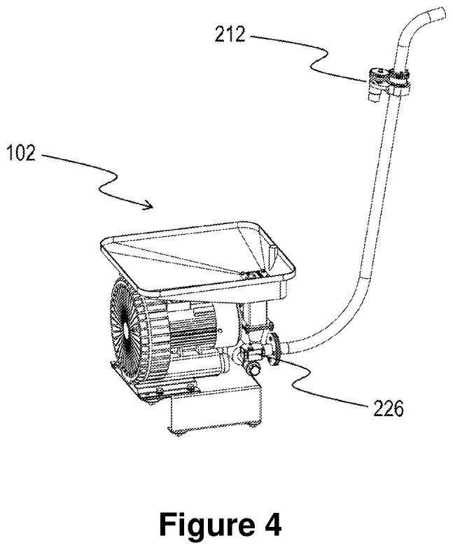

The swing mechanism 212 is mounted on a support arm 210 extending substantially horizontally from an upper portion of the front wall of the body 200. The support arm 210 comprises a communication interface 218 mounted thereon for connecting the feeder 104 to one or more communications networks. As a non-limiting example, the communication interface 218 may comprise one or more 3G, 4G, 5G, NFC, antennas, and Wi-Fi® and GPS communication modules. In one or more embodiments, data including GPS locations may be uploaded at predetermined intervals of time to a database (not depicted in FIG. 4) for storage thereof.

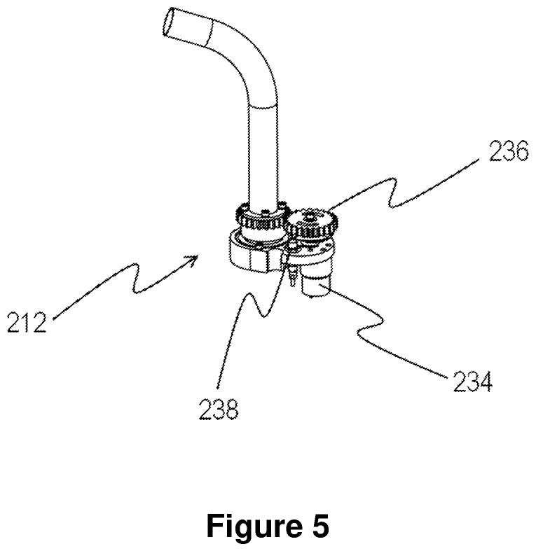

As best seen in FIG. 5, the swing mechanism 212 comprises a base (not numbered) on which two guiding gears 236 are rotatably mounted. A first gear (not numbered) defines an opening in which the feed pipe 208 extends and is secured to the first gear. The second gear is rotatably and operatively connected to a servo motor 234 mounted below the base which is operable to induce back and forth rotative motion to the second gear, which is transferred to the first gear coupled to the second gear and which causes the feed pipe 208 to swing back and forth at different angles. A swinging angle sensor 238 is mounted on the base below the two guiding gears 236 for sensing the angle of rotation. The swing mechanism 212 is operatively connected to a controller (not depicted in FIG. 5) which may selectively activate and deactivate the servo motor 234 and receive the angle sensed by the swinging angle sensor 238.

As a non-limiting example, the swing mechanism 212 may have a swing angle for the feed dispensing nozzle 214 that is between 90 and 160 degree depending on the area of the pond 102. As a non-limiting example, for a circular pond, the swing angle may be the following: 140 degree for a pond area of 1,200 m², 135 degree for a pond size of 1,000 m², 130 degree for a pond area of 750 m², and 120 degree for a pond area of 500 m².

The support arm 210 comprises an indicator light 216 mounted thereon and extending vertically therefrom and connected to a circuitry and controller (not depicted in FIG. 2) of the feeder 104. The indicator light 216 may be used as a non-limiting example for indicating a level of aquafeed in the feeder 104, an operating status of the feeder 104, for identifying the feeder 104 and the like. In one or more alternative embodiments, the indicator light 216 may be optional.

Now turning to FIG. 3, a cross-sectional view of the feeder 104 is illustrated in accordance with one or more non-limiting embodiments of the present technology.

The feeder 104 comprises inter alia a feed container 228, the locking mechanism 230, a feed sensor 232, a feed dosing mechanism 226, a controller 224, and an electrical air blower 222 supported by a base 220.

The feed container 228 is disposed in the cavity 206 and its upper portion is secured to the interior walls of the body 200 via fasteners to cover substantially the area of the cavity 206. The feed container 228 is secured such that aquafeed may fill the feeder 104 from the feed container 228 up to about the locking mechanism 230.

In one or more embodiments, a lid closing sensor (not separately numbered) is located adjacent to the locking mechanism at an upper portion of the interior walls of the body 200 operatively connected to the controller 224. The lid closing sensor is operable to detect if the lid 202 is in the open or closed position and/or if the locking mechanism is engaged or disengaged.

The feed sensor 232 is secured next to the locking mechanism 230 and operatively connected to the controller 224. The feed sensor 232 is configured to quantify the amount of aquafeed in the feeder 104.

The feed container 228 is substantially shaped as a rectangular funnel i.e., its side walls (not numbered) extend downwardly from the interior walls of the body 200 to form an opening which is narrower than the opening defined by the cavity 206. The lower portion of the feed container 228 extends downwardly to form a rectangular shaped tunnel which is in communication with a feed dosing mechanism 226 to an amount of aquafeed pass through.

The feed dosing mechanism 226 is operable to quantify the amount of aquafeed passing through the lower portion of the feed container 228, which will be distributed in the pond 102.

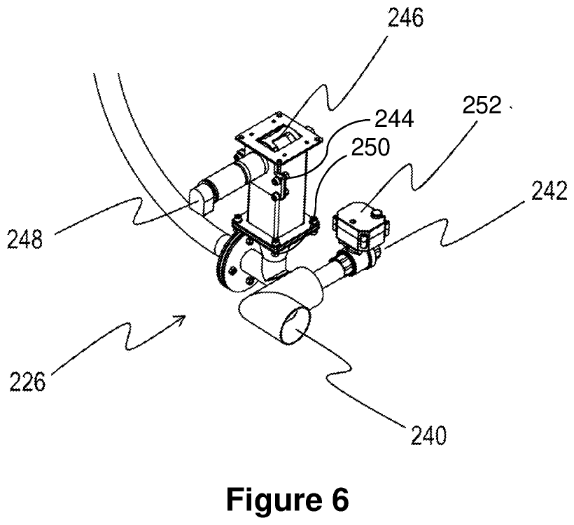

As best seen in FIG. 6, the feed dosing mechanism 226 comprises a base 244 on which is mounted a aquafeed dosing rotor 246 operatively and rotatively connected to a servo motor 248, which is operable to cause rotation of the aquafeed dosing rotor 246 to let a quantity aquafeed pass down through the base 244 to be received by a aquafeed inlet 250. It will be appreciated that the amount of aquafeed passing through the base 244 depends on the size and shape of each of the base 244 and the aquafeed dosing rotor 246 and the size and weight of the aquafeed.

The aquafeed inlet 250 is in fluid communication with an air inlet 240, an air outlet 242 and the feed pipe 208. A servo motor 252 is connected to the air outlet 242 for controlling a spraying radius of the aquafeed, and the air inlet 240 is in fluid communication with the electrical air blower 222. The servo motor 252 and electrical air blower 222 are connected to the controller 224.

The electrical air blower 222 is selectively activated and deactivated by the controller 224. When the electrical air blower 222 is activated, aquafeed passing through the feed dosing mechanism 226 is blown by the air flow created in the air inlet 240 by the electrical air blower 222 and passes through the feed pipe 208 up to the feed dispensing nozzle 214 and is projected into the air to fall into the pond 102. In an embodiment, the air blower 222 is adapted to project the aquafeed to a distance of 3 m to 14 m according to various parameters such as the size of the grow out pond, the size and weight of the aquafeed and the air blower 222 settings as directed by controller 224. The controller 224 is operable to activate the swing mechanism 212 such that aquafeed is distributed as evenly as possible on the surface of the pond 102.

The controller 224 may activate and deactivate as well as control parameters of the different components of the grow out system 100. In one or more embodiments, the controller 224 is implemented as a microcontroller. In one or more other embodiments, the controller 224 is implemented as a system on a chip (SoC).

The controller 224 is configured to or operable to inter alia: (i) receive signals from the feed sensor 232; (ii) receive signals from the lid closing sensor and the locking mechanism 230; (iii) receive from and transmit signals to the communication interface 218 and/or an electronic device; (iv) control the locking mechanism 230 of the feeder 104; (v) control the feed dosing mechanism 226; (vi) control the electrical air blower 222; (vii) control the swing mechanism 212; and (viii) control the indicator light 216.

It will be appreciated that the controller 224 may control the different components by selectively activating and deactivating as well as adjusting settings (e.g. speed) of the different components.

In one or more embodiments, the controller 224 is further configured to operable to control other components (not depicted) of the grow out system 100, such as one or more of water pump, aeration systems, water heater, supply of chemicals (e.g. salt, potassium permanganate, sumithion, melathion, formalin, bleaching powder, alum, lime, dolomite, gypsum and malachite green), which enable to control directly or indirectly water quality parameters and/or shellfish or fish health parameters of the grow out system 100.

In one or more embodiments, the controller 224 may transmit and receive signals via the communication interface 218 over a communications network (not depicted in FIG. 4). The controller 224 may as a non-limiting example receive control commands from an electronic device (not depicted in FIG. 4) to control one or more components of the feeder 104 connected to the controller 224.

Aquaculture Communication System

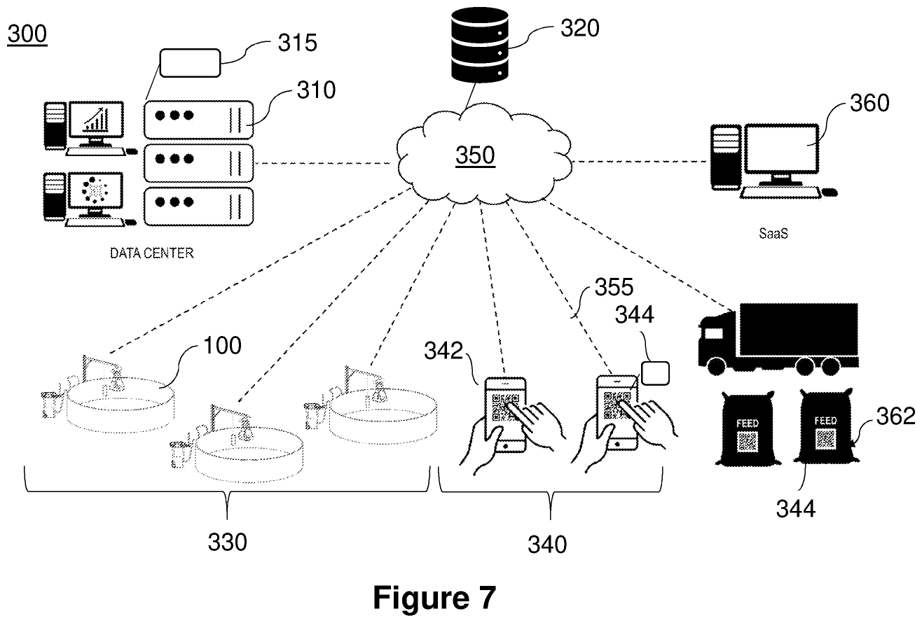

With reference to FIG. 7, there is shown a schematic diagram of an aquaculture communication system 300, the aquaculture communication system 300 being suitable for implementing one or more non-limiting embodiments of the present technology.

The aquaculture communication system 300 comprises inter alia one or more servers 310, a database 320, a plurality of aquaculture grow out systems 330, a plurality of client devices 340, and an e-commerce platform 360 communicatively coupled over a communications network 350 via respective communication links 355 (only one numbered in FIG. 7).

Aquaculture Grow Out Systems

The plurality of aquaculture grow out systems 330 comprises one or more pond monitoring systems such as the grow out system 100 (only one numbered in FIG. 7) located at different geographical locations, as a non-limiting example within an aquaculture farm, different aquaculture farms, city, region and the like. The plurality of aquaculture grow out systems 330 may be operated by a single entity or by more than one entity.

Each of the plurality of aquaculture grow out systems 330 is coupled to the communications network 350 for receiving and transmitting data. The type of data transmitted between components of the communication network 350 is not limited and may include any type of digital data. In one or more embodiments, the plurality of aquaculture grow out systems 330 are coupled to the communication network 350 via respective communication interfaces, such as the communication interface 218.

At least a portion of the parameters and components of the plurality of aquaculture grow out systems 330 may be accessible and/or controlled by one or more devices connected to the communications network 350.

Server

The server 310 is configured to: (i) exchange data with one or more of the plurality of aquaculture grow out systems 330, the plurality of client devices 340, and the e-commerce platform 360; (ii) analyze data exchanged between the plurality of aquaculture grow out systems 330, the plurality of client devices 340, and the e-commerce platform 360; (iii) access a set of machine learning algorithms (MLAs) 315; (iv) train the set of MLAs 315 to perform analysis and provide recommendations related to the plurality of aquaculture grow out systems 330 and (v) provide recommendations using the set of MLAs 315.

How the server 310 is configured to do so will be explained in more detail herein below.

It will be appreciated that the server 310 can be implemented as a conventional computer server. The server 310 comprises inter alia a processing unit operatively connected to a non-transitory storage medium and one or more input/output devices. In a non-limiting example of one or more embodiments of the present technology, the server 310 is implemented as a server running an operating system (OS). Needless to say the server 310 may be implemented in any suitable hardware and/or software and/or firmware or a combination thereof. In the disclosed non-limiting embodiment of present technology, the server 310 is a single server. In one or more alternative non-limiting embodiments of the present technology, the functionality of the server 310 may be distributed and may be implemented via multiple servers (not shown).

The implementation of the server 310 is well known to the person skilled in the art. However, the server 310 comprises a communication interface (not shown) configured to communicate with various entities (such as the database 320, for example and other devices potentially coupled to the communication network 350) via the network. The server 310 further comprises at least one computer processing unit operationally connected with the communication interface and structured and configured to execute various processes to be described herein.

Machine Learning Algorithm (MLA)

The server 310 has access the set of MLAs 315 which includes one or more machine learning algorithms (MLAs).

Once trained, the set of MLAs 315 is configured to or operable to inter alia, for a given grow out system 100 of the plurality of aquaculture grow out systems 330: (i) receive sensor data from the set of sensors 106 including one or more of images, water quality parameters, fish or shellfish health parameters, and weather conditions; (ii) determine, based on the sensor data, a current condition of the grow out system 100 including water quality and fish or shellfish health; (iii) provide recommendations based on the current conditions of the grow out system 100, including aquafeed quantity recommendations and water quality improvement recommendations; and (iv) transmit commands to the controller 224 for distribution of an optimal quantity of aquafeed in the pond 102 based on the current conditions of the grow out system 100. It will be appreciated that the aquafeed quantity recommendations may include aquafeed type, aquafeed weight, aquafeed size, and feed schedule.

In one or more embodiments, the set of MLAs 315 is further configured to automatically order products such as aquafeed from the e-commerce platform 360 based on the current conditions of the grow out system 110.

The set of MLAs 315 is trained such that health and growth of the fishes or shellfishes, usage of the aquafeed and water quality is optimized and to minimize human intervention in the growth process of the fishes or shellfishes in the pond 102. The set of MLAs 315 is trained in a semi-supervised or supervised manner to learn correlations and interactions between different water quality parameters, such as but not limited to the DO, temperature, pH, salinity, carbon dioxide (CO₂), ammonia, nitrite, hardness, alkalinity, hydrogen sulfide (H₂S), biological oxygen demand (BOD), as well as the fish or shellfish health parameters such as, but not limited to, biomass, health, size, age, presence of disease, and the like.

There can be various problems associated with handling and storing aquafeeds, including nutrient losses, growth of microorganisms, insect and rodent infestations, and rancidity. Nutrient losses occur when essential nutrients like some vitamins degrade as feed ages, particularly under storage conditions of high ambient humidity and temperature. Thus, the set of MLAs 315 enables optimizing the usage and distribution of aquafeed to minimize losses, promote growth of the aquatic species and water quality of the pond 102.

To achieve that objective, the set of MLAs 315 undergoes a training routine based on historical data of fish or shellfish grow out systems such as the grow out system 100, as well as other known parameters from the literature or input by operators.

In one or more embodiments, a given one of the set of MLAs 315 may be trained to determine a metered quantity of aquafeed to provide to the pond 102 based on the sensor data of the set of sensors 106, which comprise water quality parameters and fish or shellfish health parameters. In one or more alternative embodiments, a rule-based system may be used for determining the metered quantity of aquafeed to provide based on the sensor data comprising the water quality parameters, the health parameters (e.g. fish or shellfish age, size and biomass, etc.), as well as environmental data (e.g. time of day, time since last feed, etc.).

It will be appreciated that the training of the set of MLAs 315 may be specific to the type of fish or shellfish grown in the pond 102, as different penaeid species have different feeding behavior, as has been reported in the literature by various authors and shrimp species, including pacific white shrimp (Litopenaeus vannamei), pacific blue shrimp (L. stylirostris), black tiger shrimp (Penaeus monodon) and other species. Some species and sizes can exhibit a more aggressive feeding behavior than others, and behavior can also be affected by environmental conditions, time of day/night, availability of natural food, shrimp density and other variables.

It will be appreciated that for each parameter, animals have a broader range of tolerance and a narrower optimum range that promotes growth, survival and overall well-being. Extreme temperatures (too high or too low) and low dissolved oxygen levels will reduce feeding rates. As a non-limiting example, recommended levels of dissolved oxygen in the industry were accepted at 2.5 to 3.0 ppm, but this level should be at least 4.0 ppm or higher, which can be challenging in semi-intensive culture systems without mechanical aeration.

As a non-limiting example, for Litopenaeus vannamei shrimps, the preferred water quality parameters are: (i) water temperature is between 28 and 30° C.; (ii) DO is >6 ppm; (iii) pH is between 7.5 and 8.0; (iv) turbidity is <30NTU; and (v) salinity is >15.0 ppt.

As a non-limiting example, shrimp molt periodically (days to weeks) during their lives, and this is a stressing period during which their appetite diminishes markedly. It can take two to five days for normal feeding to resume, so it is important to recognize when there is a significant reduction in feed consumption (use of feed trays is a good method) indicating high incidence of molting in a pond, and adjust feeding rates accordingly to avoid feed wastage.

Thus, the set of MLAs 315 is trained to optimize such conditions. The set of MLAs 315 provides recommendations with regard to the water quality parameters and the fish or shellfish health parameters. In one or more embodiments, the set of MLAs 315 may further automatically adjust one or more of the water quality or health parameters (e.g. by providing instructions to the controller 224) or provide recommendations to operators to do so (e.g. by recommending additions of chemicals to the pond 102, or by raising or lowering the temperature of the pond 102.)

In one or more embodiments, the server 310 may execute the set of MLAs 315. In one or more alternative embodiments, the set of MLAs 315 may be executed by another server (not depicted), and the server 310 may access the set of MLAs 315 for training or for use by connecting to the server (not shown) via an API (not depicted), and specify parameters of the set of MLAs 315, transmit data to and/or receive data from the set of MLAs 315, without directly executing the set of MLAs 315.

As a non-limiting example, one or more MLAs of the set of MLAs 315 may be hosted on a cloud service providing a machine learning API.

It will be appreciated that the functionality of the server 310 may be executed by other electronic devices such as one or more of the plurality of client devices 340 and the plurality of aquaculture grow out systems 330.

Database

A database 320 is communicatively coupled to the server 310 via the communications network 350 but, in one or more alternative implementations, the database 320 may be communicatively coupled to the server 310 without departing from the teachings of the present technology. Although the database 320 is illustrated schematically herein as a single entity, it will be appreciated that the database 320 may be configured in a distributed manner, for example, the database 320 may have different components, each component being configured for a particular kind of retrieval therefrom or storage therein.

The database 320 may be a structured collection of data, irrespective of its particular structure or the computer hardware on which data is stored, implemented or otherwise rendered available for use. The database 320 may reside on the same hardware as a process that stores or makes use of the information stored in the database 320 or it may reside on separate hardware, such as on the server 310. The database 320 may receive data from the server 310 for storage thereof and may provide stored data to the server 310 for use thereof.

In one or more embodiments of the present technology, the database 320 is configured to inter alia: (i) store information relative to the plurality of aquaculture grow out systems 330, including location; (ii) store data relative to users of the plurality of client devices 340 (iii) store sensor data including images captured by the plurality of aquaculture grow out systems 330; and (iv) store parameters of the set of MLAs 315.

As a non-limiting example, the database 320 may store information such as distributed aquafeed quantities, duration and feeding times for traceability purposes.

Client Devices

The aquaculture communication system 300 comprises the plurality of client devices 340 associated respectively with a plurality of users (not depicted). As a non-limiting example, the plurality of client devices 340 comprises a first client device 342 associated with a first user (not depicted) which is implemented as a smartphone. It will be appreciated that each of the plurality of client device 340 may be implemented as a different type of electronic device, such as but not limited to desktops, laptops, netbooks, etc.), smartphones, and tablets, as well as network equipment such as routers, switches, and gateways. The number of the plurality of client devices 340 is not limited.

In one or more embodiments, each of the plurality of client devices 340 has access to an application 344, which as a non-limiting example may be standalone software or accessible via a browser. The application 344 may enable a user associated with one of the plurality of client devices 340, such as the first user associated with the first client device 342, to access parameters of the plurality of aquaculture grow out systems 330. It will be appreciated that different users may have different privileges and access to different options of the pond monitoring systems 330. As a non-limiting example, the first user associated with the first client device 342 may be a worker of a given one of the plurality of aquaculture grow out systems 330, and may need to authenticate using the application 344.

In one or more embodiments, the application 344 provides weather data, pond parameter data (water quality), fish or shellfish data (identification, counts, size estimation), photographs of the fish or shellfish, the data progression over time with hourly data for each installation of the network of grow out systems 100 along with their geographical location on a map. The application 344 also provides advertising space for product placement. The application 344 also provides advice and tutorial means for aquaculture of fish and shellfish as well as instant communication means to delegated staff that may answer questions from users.

E-Commerce Platform

In one or more embodiments, the aquaculture communication system 300 comprises an e-commerce platform 360.

The e-commerce platform 360 may be hosted on the server 310 or on another server (not depicted). The e-commerce platform 360 may be a website and/or a standalone software accessible by users via the plurality of client devices 340. In one or more embodiments, the e-commerce platform 360 is accessible via the application 344.

The e-commerce platform 360 provides commercial products such as aquafeed bags 362 for fish and shellfish, and aquaculture products for delivery to operators of the plurality of aquaculture grow out systems 330. The products provided by the e-commerce platform 360 such as aquafeed bags 362 may comprise a unique aquafeed identifier 364 such as a QR code which may be transmitted to each of the plurality of aquaculture grow out systems 330 upon purchase to ensure that purchased aquafeed bags are received at the respective one of the plurality of aquaculture grow out systems 330. In one or more embodiments, the set of MLAs 215 may automatically or semi-automatically (e.g. upon receipt of confirmation from an operator) order aquafeed from the e-commerce platform 360, which may be specific to the conditions of each of the plurality of aquaculture grow out system 330.

For traceability, aquafeed in the form of feed pellets are contained in a polypropylene woven bag, i.e. aquafeed bags 362, where each bag comprises about 25 kg of feed pellets. Depending on the age of shellfish such as shrimps, the size of the feed pellets varies from 1.8 to 6.0 mm. The unique aquafeed identifier 364 is printed on the aquafeed bag to contain information including name of the manufacturer, production location, list of the ingredients and their percentage, the net weight, production date and expired date.

Each aquafeed bag 362 may be associated with a respective feeder 104 of a grow out system 100 for which it was ordered depending on the growth stage of the fish or shrimp, and the required aquafeed quantity or size. Thus, to fill a respective feeder 104 with aquafeed, the unique aquafeed identifier 364 may be scanned on the purchased aquafeed bags 362 associated with a respective feeder 104 by a worker using an electronic device such as a smartphone comprising the application 344, and the unique identifier 219 of the feeder 104 may be compared with the associated unique aquafeed identifier 364 of the aquafeed bags 362. In one or more embodiments, the analysis may be performed locally by the server 310 or the plurality of client devices before being transmitted to the e-commerce platform 360. It will be appreciated that different techniques may be used to ensure that the aquafeed bags 362 are used for the right respective feeders 104, e.g. using the communication interfaces of the feeders (e.g. Bluetooth®, RFID, NFC, etc.), unique identifiers such as the unique identifier 219 and the unique aquafeed identifier 364, detected proximity and the like without departing from the scope of the present technology.

If the comparison results in a match, the communication interface 218 may receive, from the server 310 or a client device, an indication that the aquafeed bags 362 is authentic, which may cause the controller 224 to transmit a signal to unlock the locking mechanism of the lid 202, which enables the worker to open the lid 202 of the feeder 104 and fill the feeder 104 with the content of the aquafeed bags 362. The controller 224 may also enable the worker to control the grow out system 100 including feeder 104 via the application 344 only if there is match between the unique identifiers.

If the comparison results in a mismatch, the worker may not have access to the feeder 104 and/or may not control the different components thereof. The comparison mismatch may be logged in the database 320, and a report of mismatches may be generated thereafter. The authentication process enables preventing that usage of the wrong aquafeed bags 362 for the pond 102, as well as preventing counterfeiting of aquafeed bags.

Communication Network

In one or more embodiments of the present technology, the communications network 350 is the Internet. In one or more alternative non-limiting embodiments, the communication network 350 may be implemented as any suitable local area network (LAN), wide area network (WAN), a private communication network or the like. It will be appreciated that implementations for the communication network 350 are for illustration purposes only. How a communication link 355 (not separately numbered) between the one or more servers 310, the plurality of aquaculture grow out systems 330, the plurality of client devices 340, and the e-commerce platform 360 and/or another electronic device (not shown) and the communications network 350 is implemented will depend inter alia on how each electronic device is implemented.

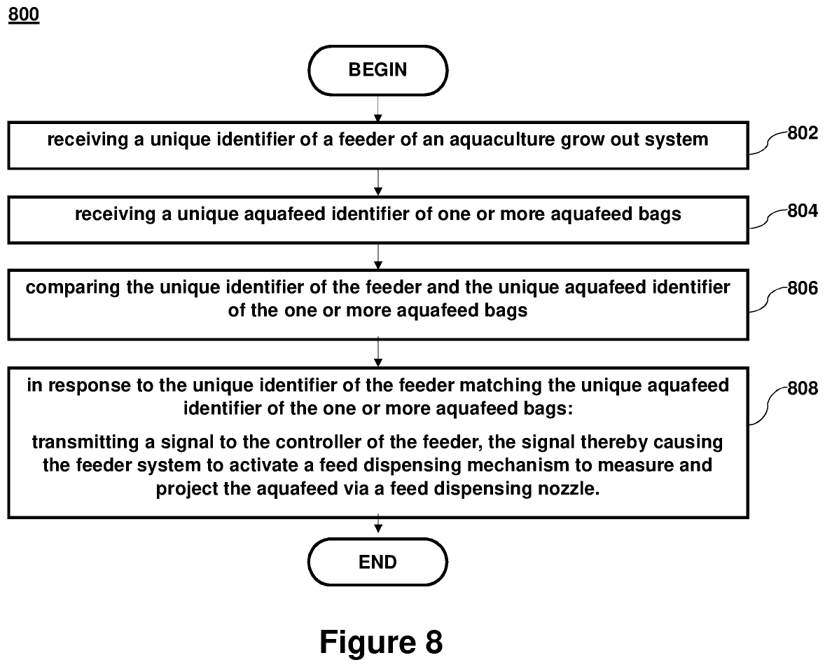

With reference to FIG. 8, a flow chart of a method 800 of operating a feeder 104 of the grow out system 100 will now be described in accordance with one or more non-limiting embodiments of the present technology.

In one or more embodiments, the method 800 is executed at least in part by a processing device operatively connected to one or more components of the feeder 104, the set of sensors 106, and. It will be appreciated that the processing device may be connected to one or more of the components via a wired connection or a wireless connection without departing from the scope of the present technology. It is contemplated that the processing unit may be located within or outside the feeder 104.

In one or more embodiments, the processing device may be the controller 224. In one or more other embodiments, the processing device may be the server 310 and/or one of the plurality of client devices 340.

In one or more embodiments, the processing device is operatively connected to a non-transitory storage medium which includes computer-readable instructions causing the processing device to execute the method 800

In one or more alternative embodiments, at least a portion of the method 800 may be executed by an operator having access to each of the components of the grow out system 100.

The method 800 begins at step 802.

At step 802, the unique identifier 219 of the feeder 104 is received. In one or more embodiments, the unique identifier 219 comprises a QR code associated with the feeder 104. The unique identifier 219 may be received from one of the plurality of client devices 340.

At step 804, the unique aquafeed identifier 364 of one or more aquafeed bags 362 is received. The one or more aquafeed bags 362 may have been ordered via an electronic device. In one or more embodiments, the aquafeed bags 362 may have been order using one of the set of MLAs 315. The unique aquafeed identifier 364 may be received from one of the plurality of client devices 340.

At step 806, the unique identifier 219 is compared with the unique aquafeed identifier 364.

At step 808, in response to the unique identifier 219 matching the unique aquafeed identifier 364, a control signal is transmitted to the controller 224, which causes the controller 224 to activate a feed dispensing mechanism to measure and project the aquafeed via a feed dispensing nozzle 214. The feed dispensing mechanism comprises the feed dosing mechanism 226, the electrical air blower 222 and the swing mechanism 212.

In one or more embodiments, the control signal may cause the controller 224 to enable the one of the plurality of client devices 340 to access and control parameters of the feeder 104.

The method 800 ends.

It should be expressly understood that not all technical effects mentioned herein need to be enjoyed in each and every embodiment of the present technology. For example, embodiments of the present technology may be implemented without the user enjoying some of these technical effects, while other non-limiting embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

What is claimed is:

1. A smart aquaculture grow out system comprising:
a feeder adapted to receive and hold aquafeed, the feeder comprising:
a feed dispensing nozzle;
a feed dispenser connected to the feed dispensing nozzle, the feed dispenser being operable to measure and project aquafeed via the feed dispensing nozzle;
a controller operatively connected to the feed dispenser, the controller being operable to selectively activate and deactivate the feed dispenser;
a set of sensors being operable to acquire sensor data of the smart aquaculture grow out system, the sensor data comprising water quality parameters of a pond adjacent to the feeder;
a processor communicatively coupled to the set of sensors and the controller, the processor being operable to:
receive, from the set of sensors, the sensor data of the grow out system including the water quality parameters;
determine, based on the sensor data of the grow out system, a metered quantity of aquafeed to provide to the pond; and
transmit, to the controller, a control signal causing activation of the feed dispenser to measure and project the metered quantity of aquafeed via the feed dispensing nozzle.

2. The smart aquaculture grow out system of claim 1, wherein the set of sensors comprises at least one of: a temperature sensor, a pH sensor, a dissolved oxygen (DO) sensor, a carbon dioxide (CO₂) sensor, an ammonia sensor (NH₃), a scale, a turbidity sensor, and a salinity sensor.

3. The smart aquaculture grow out system of claim 1 or 2, wherein
the set of sensors comprises a camera operable to acquire an image of an aquatic species located in the pond; wherein
the processor is operable to determine, based on the image, an approximate size of the aquatic species; and wherein
the processor is operable to determine the metered quantity of aquafeed further based on the approximate size of the aquatic species.

4. The smart aquaculture grow out system of claim 3, wherein
the processor is operable to determine, based on the image, an approximate biomass of the aquatic species in the pond; and wherein
the processor is operable to determine the metered quantity of aquafeed further based on the approximate biomass of the aquatic species.

5. The smart aquaculture grow out system of claim 3 or 4, wherein the metered quantity of aquafeed comprises: a feed pellet size and a feed pellet weight.

6. The smart aquaculture grow out system of any one of claims 1 to 5, wherein the processor has access to a set of machine learning algorithms (MLAs) having been trained to determine the metered quantity of aquafeed based on the sensor data comprising water quality parameters and images.

7. The smart aquaculture grow out system of claim 6, wherein the set of machine learning algorithms (MLAs) has been trained to determine the metered quantity of aquafeed further based on an approximate biomass of an aquatic species and an approximate size of the aquatic species.

8. The smart aquaculture grow out system of any one of claims 1 to 7, wherein the processor is further operable to:
transmit, over a communication network, an indication to order an aquafeed bag comprising at least the metered quantity of aquafeed.

9. The smart aquaculture grow out system of any one of claims 1 to 8, wherein the feed dispenser comprises:
a feed dosing mechanism operatively connected to the controller and being operable to provide the metered quantity of aquafeed to an aquafeed inlet; and
an air blower in fluid communication with an air inlet, the air inlet being connected to the aquafeed inlet and a feed tube, the air blower being operatively connected to the controller, the air blower being operable to generate an airflow to project the metered quantity of aquafeed received from the aquafeed inlet via the feed dispensing nozzle through the feed tube.

10. The smart aquaculture grow out system of any one of claims 1 to 9, further comprising a nozzle swing mechanism operatively connected to the feed dispensing nozzle, the nozzle swing mechanism being operable to provide rotative motion to the feed dispensing nozzle to project the metered quantity of food at different angles at a surface of the pond.

11. The smart aquaculture grow out system of claim 10, wherein the nozzle swing mechanism comprises:
a first gear defining an opening for securing at least a portion of the nozzle;
a second gear coupled to the first gear; and
a servo motor operatively and rotatably connected to the first gear to provide rotative motion thereto.

12. The smart aquaculture grow out system of claim 10 or 11, wherein the nozzle swing mechanism is operable to rotate between about −90 degrees to about +90 degrees when the feed dispensing nozzle is directed at a center of the pond.

13. The smart aquaculture grow out system of any one of claims 1 to 12, wherein the set of sensors further comprises a weather sensor operable to measure at least one of temperature, humidity, wind speed, wind direction and rain.

14. The smart aquaculture grow out system of any one of claims 1 to 13, wherein
the feeder comprises a body and a lid for covering the body; and
a locking mechanism operatively connected to the controller for locking the lid to the body; and wherein
the controller is operable to selectively lock and unlock the locking mechanism upon receipt of another control signal.

15. The smart aquaculture grow out system of claim 14, wherein
the feeder is associated with a unique identifier; and wherein
the controller is operable to selectively unlock the locking mechanism upon the receipt of the other control signal, the other control signal being indicative of a match between the unique identifier of the feeder and a unique identifier of an aquafeed bag.

16. The smart aquaculture grow out system of claim 14 or 15, wherein the controller is operable to transmit the control signal causing activation of the feed dispenser to measure and project the metered quantity of aquafeed via the feed dispensing nozzle only upon receipt of the other control signal.

17. The smart aquaculture grow out system of any one of claims 1 to 16, wherein the aquatic species comprises one of fish and shellfish.

18. The smart aquaculture grow out system of claim 17, wherein the shellfish comprises one of shrimp and prawn.

19. The smart aquaculture grow out system of any one of claims 1 to 18, wherein the controller comprises the processor.

20. The smart aquaculture grow out system of any one of claims 1 to 19 wherein the feeder and sensor data provide traceability of the provenance and aquaculture conditions.

21. The smart aquaculture grow out system of claim 20 wherein the provenance and aquaculture conditions and feed source include the geographical location of the grow out pond, feed manufacturer, production location, feed ingredients, production date and feeding conditions.

22. A feeder system comprising:
a feed container for receiving aquafeed, the feed container defining a channel extending downwardly from a lower portion thereof;
a feed dosing mechanism connectable to the channel, the feed dosing mechanism being operable to supply aquafeed through the channel;
a feed dispenser connectable to the channel and to a feed dispensing nozzle, the feed dispenser being operable to project aquafeed from the channel up to the feed dispensing nozzle; and
a controller operatively connectable to the feed dosing mechanism and the feed dispenser, the controller being operable to:
receive an indication to provide aquafeed;
activate, based on the indication, the feed dosing mechanism to supply a metered quantity of aquafeed; and
activate, based on the indication, the feed dispenser to project the metered quantity of aquafeed from the nozzle.

23. The feeder system of claim 22, wherein
the feeder system is associated with a unique identifier; and wherein
the indication to provide aquafeed comprises a match between the unique identifier of the feeder system and a match between a unique identifier associated with the aquafeed.

24. A shellfish feeding and growth system comprising:
a feeder system adapted to receive and hold a supply of shellfish feed pellets, said feeder system adapted to throw metered amounts of the feed pellets into a pond or vessel containing shellfish at calculated and discrete time intervals in response to commands from a controller,
a controller being responsive to a central processing unit or network link providing commands to said feeder system;
a central processing unit or network link receiving inputs provided by sensors located in or around said pond or vessel, determining with one or more algorithms the required time intervals and metered amounts of the pellets and providing commands to said controller,
said inputs comprising inputs being provided by sensors within said pond or vessel, including a pH sensor, a temperature sensor, a turbidity sensor, a salinity sensor and a dissolved oxygen sensor.

25. A method of operating an aquafeed feeder system, the aquafeed feeder system being associated with a feeder unique identifier, the method being executed by a processor, the processor being connected to a controller of the aquafeed feeder system, the method comprising:
receiving the feeder unique identifier associated with the aquafeed feeder system;
receiving an aquafeed unique identifier associated with an aquafeed bag;
in response to the feeder unique identifier of the aquafeed feeder system matching the aquafeed unique identifier associated with the aquafeed bag:
transmitting a signal to the controller of the aquafeed feeder system, the signal thereby causing the aquafeed feeder system to activate a feed dispensing mechanism to measure and project the aquafeed via a feed dispensing nozzle.

26. The method of claim 25, wherein the aquafeed unique identifier and the feeder unique identifier comprise a respective QR code.

27. The method of claim 25 or 26, further comprising, prior to said transmitting the signal to the controller:
receiving an approximate biomass and an approximate size of aquatic species;
determining, based on the approximate biomass and the approximate size of the aquatic species, a metered quantity of aquafeed to provide to the aquatic species; and wherein
the signal comprises an indication of the metered quantity of aquafeed.

28. The method of claim 27, further comprising,
prior to said determining of the metered quantity of aquafeed to provide the aquatic species:
receiving water quality parameters of a pond comprising the aquatic species; and wherein
said determining the metered quantity of aquafeed to provide the aquatic species if further based on the water quality parameters.
